(19) United States
(12) Patent Application Publication
(10) Pub. No.: US 2012/0246695 A1
(43) Pub. Date: Sep. 27, 2012

(54) ACCESS CONTROL OF DISTRIBUTED COMPUTING RESOURCES SYSTEM AND METHOD

(76) Inventor: Alexander Cameron, Surrey Downs (AU)

(21) Appl. No.: 13/319,387

(22) PCT Filed: May 8, 2009
(86) PCT No.: PCT/AU09/00560

§ 371 Date: Apr. 27, 2012

(51) Int. Cl. G06F 21/00; G06F 9/44

(52) U.S. Cl. 726/1

(57) ABSTRACT

A system (100) and method (200) for controlling access to distributed computing resources is described. The system has one or more computing resources (114), an identity manager (102) and a distributor (106). The identity manager registers (204) a plurality of users and creates an access policy. The access policy comprises a set of rules that enable determination of access privileges of each registered user to access the computing resources. The distributor is arranged to distribute (208) the access policy to the computing resources. Each of the computing resources has a policy applicator (110) for determining (210) the access privileges from the distributed access policy. Each policy applicator also determines (212) whether the determined access privileges permit access to the respective computing resource when one of the registered users attempts to access the respective computing resource. Each policy applicator also allows (216) access to the respective computing resource when the one of the registered users is permitted access thereto.

### BACKGROUND OF THE INVENTION

Enterprise level user single sign-on is becoming more accepted for allowing a user to access distributed resources across a computer network. Typically a user provides a user name and password, which are authenticated, often locally but sometimes remotely by a centralised system. When the user desires to use a resource, such as an application, service or system at a remote location on the computer network, a centralised authorization system is typically used to determine whether the user is allowed to access that resource. However, the use of such a centralized authorization system may create a bottleneck at the authorization system, limit scalability and limit the ability of some systems—such as loosely coupled service based systems—to operate in a network-centric manner.

### DESCRIPTION OF DRAWINGS

In order to provide a better understanding, embodiments of the present invention will be described in detail with reference to the accompanying drawings, in which:

FIG. 1 is a schematic diagram of an embodiment of an access control system of the present invention.

FIG. 2 is a flow chart of a method of access control according to an embodiment of the present invention.

FIG. 3 is a schematic diagram of an embodiment of an abstraction of relationships between components of the system of FIG. 1.

FIG. 4 is a sequence diagram of an embodiment of a provisioning method of the present invention.

FIG. 5 is a sequence diagram of an embodiment of an access method of the present invention.

### DETAILED DESCRIPTION OF THE EMBODIMENTS

There will be provided a method and system for controlling access to distributed computing resources (including any electronic device, such as a computing device, with an operating system).

According to an embodiment of the present invention there is provided a system for controlling access to distributed computing resources, the system comprising:
one or more computing resources;
an identity manager arranged to register a plurality of users and create an access policy that comprises a set of rules that enable determination of access privileges of each registered user to access one or more of the computing resources;
a distributor arranged to distribute the access policy to the one or more computing resources;
wherein each of the one or more computing resources have a policy applicator for determining the access privileges for the respective computing resource from the distributed access policy, for determining whether the determined access privileges permit access to the respective computing resource when one of the registered users attempts to access the respective computing resource and for allowing access to the respective computing resource when the one of the registered users is permitted access thereto.

The identity manager may be configured to create the access policy by associating each user with one or more of a plurality of roles, where each role has a predetermined associated set of computing resource access privileges, and recording each association.

The distributor may be configured to distribute the access policy in the form of the recorded associations between each user and one or more roles and each role and the associated set of computing resource access privileges.

The distributor may be configured to distribute the access policy in the form of recorded associations between each user and access privileges for one or more of the computing resources.

The privilege distributor may be arranged to only distribute one or more portions of the access policy to those computing resources for which the portions are relevant.

Each policy applicator may comprise a storage device for storing the distributed access policy.

According to another embodiment, there is provided a method of controlling access to one or more distributed computing resources, the method comprising:
distributing an access policy that comprises a set of rules that enable determination of access privileges of a registered user to access one or more of the computing resources to the one or more computing resources;
determining the access privileges for each respective computing resource from the distributed access policy;
determining whether the access privileges permit access to one of the respective resources when the registered user attempts to access the respective resource; and
allowing access to the respective computing resource when the registered user is permitted access thereto.

In an embodiment the method further comprises creating an access policy in the form of associations between each user and one or more roles, and associations between each role and one or more access privileges to one or more of the computing resources.

According to another embodiment, there is provided an identity management system for controlling access to distributed computing resources, wherein the resources each have a policy applicator for applying a distributed access policy so as to permit or deny access to the respective resource when a registered user attempts to access the resource, the identity management system comprising:
an identity manager arranged to register a plurality of users and create an access policy that comprises a set of rules that enable determination of access privileges of each of the registered users to access one or more computing resources; and
a distributor arranged to distribute the access policy to the one or more computing resources;
wherein the distributed access policy is suitable for the policy applicator of each resource to determine access privileges of the registered users to access the respective computing resource from the distributed access policy, to determine whether the access privileges permit access to the respective computing resource when a registered user attempts to access the respective resource, and to allow access to the respective computing resource when the user attempting access is permitted access thereto.

According to an embodiment, there is provided a method of controlling access to distributed computing resources, wherein the one or more resources each has a policy applicator for applying a distributed access policy so as to permit or deny access to the respective resource when a user attempts to access the computing resource, the method comprising:
creating an access policy that comprises a set of rules that enable determination of access privileges of a registered user to access one or more of the computing resources;
distributing the access policy to the one or more computing policy resources;
wherein the distributed access policy is suitable for the applicator of each resource to determine access privileges of the registered users to access the respective computing resource from the distributed access policy, to determined whether the access privileges permit access the respective resource, and to allow access to the respective computing resource when the user attempting access is permitted access thereto.

According to another embodiment, there is provided a computing resource comprising:
a receiver of an access policy from an identity manager that is arranged to register a plurality of users and create the access policy, where the access policy comprises a set of rules that enable determination of access privileges of each registered user to access one or more of the computing resources; and
a policy applicator for determining access privileges of the registered users to access the computing resource, for determining whether the access privileges permit access to the computing resource when one or the registered users attempts to access the computing resource, and for allowing access to the respective computing resource when the registered user is permitted access thereto.

According to another embodiment, there is provided a method of authorising access to a computing resource, the method comprising:
receiving an access policy at a policy applicator of a computing resource from an identity manager which is arranged to register a plurality of users and create an access policy, where the access policy comprises a set of rules that enable determination of access privileges of each registered user to access one or more of the computing resources;
determining access privileges of the registered users to access the computing resource from the received access policy;
determining whether the access privileges permit access to the computing resource when one or the users attempts to access the computing resource; and
allowing access to the respective computing resource when the registered user is permitted access thereto.

According to another embodiment, there is provided a computer program embodied in a computer readable medium, the program comprising instructions for controlling a computer to perform one or more of the above methods.

According to another embodiment there is provided a computing program embodied in a computing readable medium, the program comprising instructions for controlling one or more computers to operate as one of the above system, identity management system or computing resource.

In a particular embodiment, the present invention provides a system for controlling access of distributed computer resources comprising an identity manager, a distributor, and a policy applicator for each resource. In an embodiment the identity manager is arranged to enrol or register a plurality of users and create an access policy which enables privileges of the registered users to access one or more computer resources to be determined. The distributor distributes the access policy to the policy applicator of each resource from the access policy. Each policy applicator determines the access privileges of the registered users to the respective computer resources. The policy applicator also applies the access privileges so as to permit or deny access to the resource when one of the users attempts to use the resource. Access to the resource is intended to include in its meaning, without being limited to, sending information to or retrieving information from the resource, as well as, other forms of use of the resource. The resource is intended to include, without being limited to, a computing facility that can be called upon to provide information or perform a computing function. A user is typically a person, but in some embodiments may be a service of a computer system.

The access control decision is decentralised and allocated to the application of the particular resource. In an embodiment the access privileges are allocated according to a role based access control approach in which one or more roles are provided to each user. Each role has one or more access privileges associated with it, thereby providing an associated set of access privileges with each user according to the role or roles allocated to them. The access privileges granted with each role may be determined by one or more enterprise policies. Alternatively, the allocated roles and access privileges of the roles may form the access policy. Alternatively, instead of a role based access control approach, an individual user attribute based access control approach can be used.

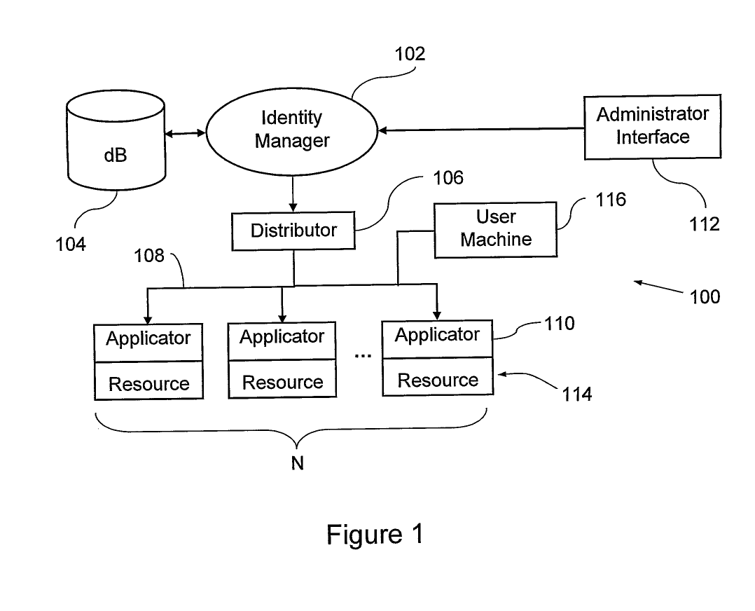

Referring to FIG. 1, for example, according to the invention there is provided a system 100 for controlling access to distributed computer resources 114. The resources are accessible over a computer network 108. One or more users may be connected to the network 108 by one or more user machines 116. A user machine 116 may be for example a personal computer in the form of, for example, a desktop, laptop, thin client or other computer. The system 100 comprises an identity manager 102, a distributor 106, and a policy applicator 110 for each resource 114. In an embodiment the identity manager 102 comprises a database 104 stored in a storage device. The database 104 is arranged to store enrolments or registrations of a plurality of users, and records of one or more resource access privileges in relation to each user. The privileges distributor 106 is arranged to distribute the access privileges in the form of a policy to each policy applicator 110. Each policy applicator 110 is arranged to store the policy in a storage device. Each policy applicator 110 is also arranged to determine the access privileges for a user seeking to use the resource. This may be by extracting or retrieving the access privileges of the relevant user from those stored or it may involve interpreting the policy by looking up the user's role (if not received from the requesting user) and then looking up the access privileges that person of that role. Each policy applicator 110 is also arranged to apply the access privileges to the user attempting to use the respective resource 114, so as to, for example, permit or deny use of the resource 114. In an embodiment the applicator 110 is implemented at a service or application level.

The system 100 may further comprise an administrator interface 112 for facilitating a person or machine interacting with the identity manager 102, so as to, for example, register users, define roles, and/or set or change access privileges for each user or each role.

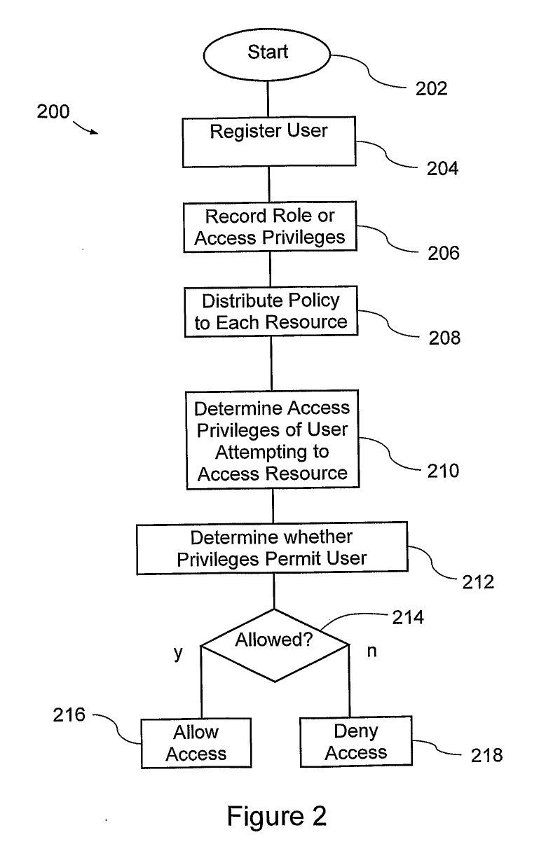

Referring to FIG. 2, a method 200 of controlling access to distributed computer resources is shown. The method 200 commences at step 202. At step 204, the identity manager registers a user. Registration comprises at least allocating an identification to the user (such as a user name used within an enterprise) and will usually also comprise allocation of a password or security token. In an embodiment the user is allocated one or more roles, each role having one or more access privileges associated with it. Thus by recording one or more roles against a user identification this will, by association, entail allocation of access privileges to the user. The access privileges may in addition, or instead, be manually allocated. The role or access privileges of the user are recorded at step 206, typically in database 104. Depending on implementation the access privileges accorded to roles or the access privileges accorded to users are regarded as an access policy. In some embodiments the roles accorded to each user may form part of the policy as well.

At step 208, the policy is distributed to applicator 110 of each resource 114. Typically the respective applicator 110 stores the distributed policy in a local storage device. The method up to and including step 208 constitutes the provision of access privileges to the resources.

Access control based on the provisioning occurs with step 210. When a user attempts to access or use a resource 114, the respective applicator 110 determines at step 210 the access privileges of the user from the policy. The applicator then determines whether at step 212 the access privileges permit the user to access the resource 114. Based on this determination, the process branches at step 214. In the event that the user is authorised, processing continues at step 216 where the user is allowed to access the resource. Otherwise, that is, the user is not authorised, processing continues at step 218 where the user is denied access to the resource.

Resources 114 may be particular software applications. They could also be services or physical systems. Resources need not be within the enterprise, and may be external resources that utilise the present invention.

The administrative function of identity management, including role creation, role membership, and role assignment of privileges (that is, policy creation and maintenance) can be centralised for consistency and control by trusted sponsors, as described further below. Further provisioning of permissions/privileges occurs so that the implementation of access control is delegated to the applicators of the relevant resources. The applicator 110 is thus able to hold a dynamic set of users that can access the respective resource in a storage directory for local implementation of the policy. Collectively the applicators allow for distributed implementation of the policy, which can alleviate bottle-necking and can achieve scalability.

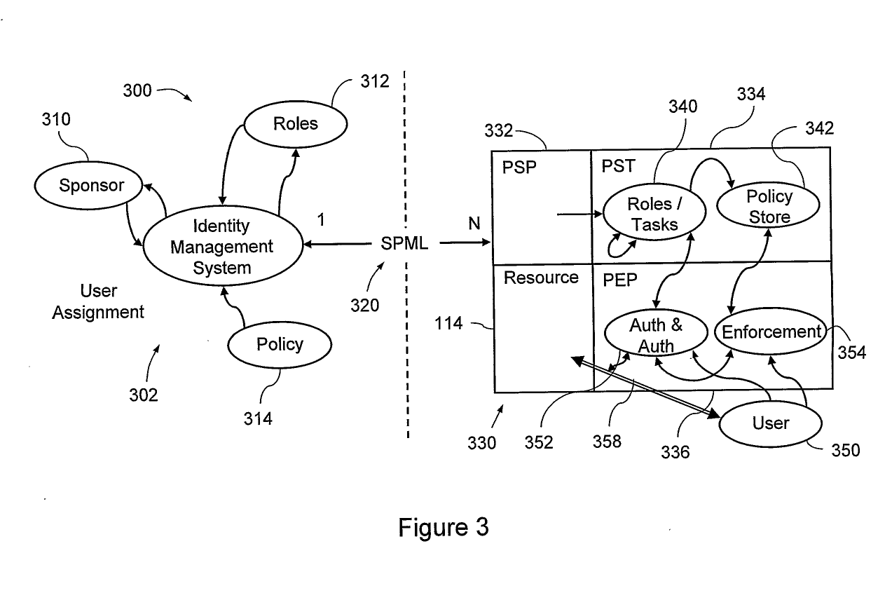

Referring to FIG. 3, relationships 300 between components of the system 100 are shown. In this Figure the identity manger 102 is related to the N resources 114. In this embodiment an identity management system 302 comprises the identity manager 102 and the distributor 106.

A sponsor 310 is able to authorise registration of a user. In an embodiment the sponsor activates a registration menu in the identity manager 102, via the administrator interface 112, enters the relevant details into a form and submits the form. The details are stored in the database 104. The sponsor 310 will usually be an authorised person within the enterprise, such as for example a manager or a member of an IT department. The sponsor 310 could also be a registration service of another computer system. The registration service may be a resource 114 and a user given a role of sponsor which entitles the user to privileges that enable the user to sponsor other users and to allocate those other users with one or more roles.

In this embodiment the enterprise may have one or more roles 312 that a user will fulfil. The enterprise may also have an enterprise policy 314 that lists the various roles and associated access privileges that a user has to access the resources of the enterprise. The roles 312 can be centrally changed by a sponsor 310 as can the enterprise policy specifying the privileges to access resources associated with each role. When a user is registered they are allocated one or more of the roles. By association and in accordance with the policy 314 each role grants certain access privileges to each user.

For example, the sponsor 310 may be a manager employing or promoting an employee to a particular position within an enterprise. In order to perform in that position the employee may be required to use various network computer resources. For example, an employee in a Finance Department will need access to an accounting system, an engineer may require access to a computer aided design system, a secretary may require access to a word processing system and a ‘basic level’ of access to the accounting system. The enterprise's policy may specify the relationship that each of these roles has with respect to the computer resources available. If the new employee (user) is an accountant he/she is allocated the ‘accountant’ role and the necessary access privileges are allocated by association according to the policy.

Once each new user is allocated to a role the allocation is recorded in the identity management system 302. The distributor 106 then distributes the allocations as an access policy, so that the user is provisioned with certain rights to access the resources 114. In an embodiment the distributor communicates over the network 108 using Service Provisioning Mark-up language (SPML) 320. SPML is an XML framework for exchanging user, resource and service provisioning information. SPML is described in more detail in SPML standards published by the Organization for the Advancement of Structured Information Standards (OASIS). Provisioning has the effect of informing each of the resources of what the user's access privileges are in relation to particular resource. Access privileges may be of a binary nature, such as the example whether or not a user is allowed to use a particular resource. Alternatively access privileges may be tiered so that a user may be allowed certain access rights to one or more levels of the resource, but are limited to that particular level. In the example above, the ‘secretary’ role is only entitled to a ‘basic’ level of access (such as queries) to the accounting system, but the ‘accountant’ role is entitled to ‘full’ access.

In an embodiment the resource 114 interfaces with “the rest of the world” through the applicator 110. Thus the resource 114 and applicator 110 appear to be a composite 330 to the rest of the network. In this embodiment the applicator 110 is in the form of a provisioning service provider (PSP) 332, a provisioning service target (PST) 334 and a policy enforcement provider (PEP) 336 which encapsulate the resource 114. The PSP 332 receives the policy from the distributor 106. In an embodiment the PSP 332 only receives parts of the policy relevant to the respective resource 114. Alternatively the PSP 332 may filter out information not relevant to this resource 114. The access policy is provided to the PST 334. The roles applicable to this resource 114 are stored in a role store 402 of a role storage component 340 of the PST 334. The role storage component 340 creates and maintains the roles stored in the role store 402. The levels of privileges of each role are stored in a policy store 404 of a policy storage component 342 of the PST 334. The policy storage component 342 creates and maintains the access privileges stored in the policy store 404.

The PEP 336 performs identity actions, such as receiving a requesting user identity 350. The PEP 336 comprises an authentication and authorisation (Auth & Auth) component 352 and an enforcement component 354. The Auth & Auth 352 is configured to authenticate identity of the user from the user identity 350, including in an embodiment requesting the role storage component 340 look in the role store 402 to find the roles of the user. The retrieved role is provided to the enforcement component 354, which requests the policy storage component 342 to look up the access privileges of the role in the policy store 404. In particular the access privileges of the role with respect to the resource 114 are determined. The enforcement component 354 then determines whether the user has the necessary privileges to perform the access requested. If so the access 358 is granted, otherwise it is denied.

In some embodiments a specific session is created for each user access request by the Auth & Auth 352, where a user may have one role in one session and another role in another session. This allows for separation of duties when performing different tasks. Further, in some embodiments a user may have a task to complete which requires different roles at different times. The roles of the task may be stored in the role store 402 so that as different phases of the task are completed the role of the user may change according to which phase the task is at.

The user may be able to pick up a session identifier when the policy determines that one is needed. For example a user may only be valid for a certain session to complete a specific task. If the user is part of a group then he can be assigned more than one role to complete a task.

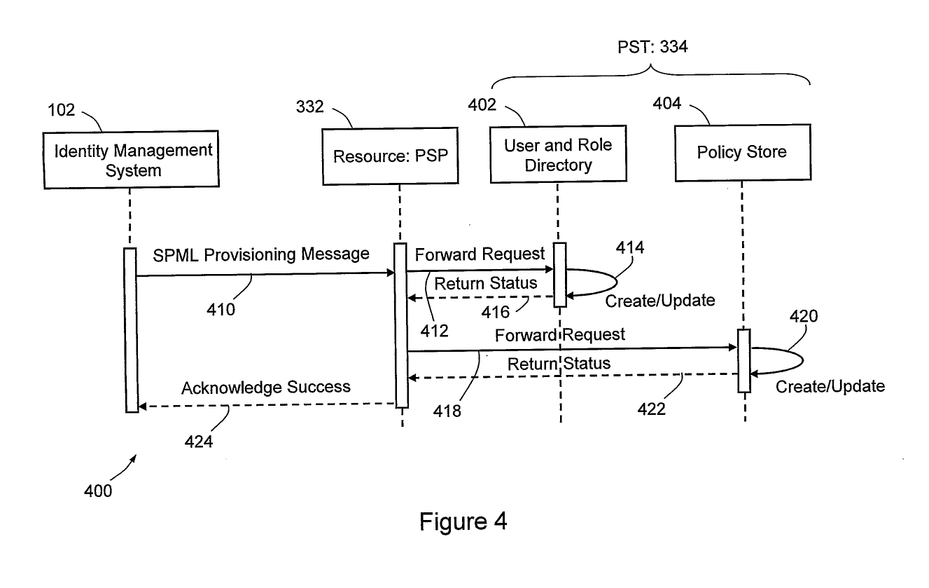

Referring to FIG. 4, an embodiment of a sequence 400 of provisioning is shown. The sequence 400 is a process of message transfers between the identity management system 102 and the PSP 332, as well as message transfers to the PST 334 and within the PST 334. The sequence 400 commences by the identity management system 102 sending a provisioning message 410 to the PSP 332 of a particular resource 114. In this embodiment, the provisioning message 410 is in SPML format, which is received and interpreted by the PSP 332 and then given to the PST 334. Within the PST 334 a provisioning request message 412 is sent to the role storage component 340. The user identity within the request message is used to determine whether the user already has a role stored in a role store 402 within the role storage component 340. If so, then the role store 402 is updated 414. If not, then a directory is created 414 for that user or role in the role store 402 and the detail saved in the directory. A return status message 416 is sent to the PSP 332. A policy request message 418 is sent to the policy storage component 342 for storage by update or creation 420 of the access privileges for the role in an appropriate directory of a policy store 404 within the policy storage component 342. A return status message 422 is sent to the PSP 332. The PSP 332 then sends an acknowledgement message 424 back to the identity manager 102.

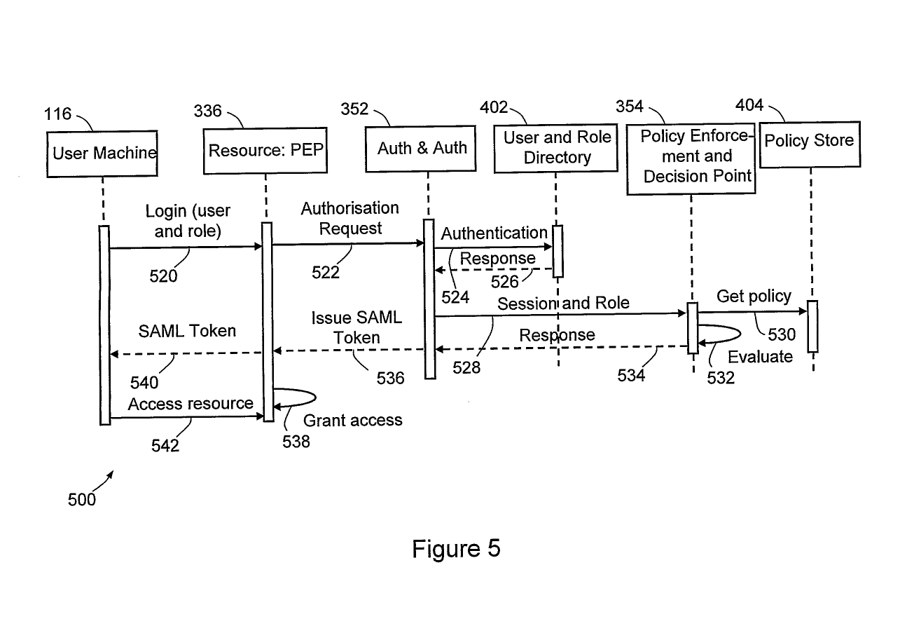

Referring to FIG. 5, an embodiment of a sequence 500 of determining whether the user has the relevant access privileges, that is access control, using the PEP 336 is shown. The sequence 500 is a process of message transfers between the user machine 116 and the PEP 336, as well as message transfers within the PEP 336 and with the PST 334. A user attempts to login to a resource 114 by the user machine 116 sending a login message 520 to the PEP 336. The login request message 520 will comprise the user identification 350 and may also include the role the user is currently filling. If the user has already logged in and established their credentials a Security Assertion Mark-up Language (SAML) token may be included. An authorisation request message 522 is created and sent to the Auth & Auth 352, which sends an identity authentication message 524 to the role storage component 340 to authenticate the user and the user's role. In one embodiment the role storage component 340 checks the user's role. In another embodiment the role storage component 340 checks that the user is provisioned with the role asserted. In another embodiment a SAML token is sent to establish the user's identity. Alternatively the SAML token may have identifying credentials and the user's role, in which case this step may be by-passed. A response message 526 is sent to the Authentication and Authorization 352. If authenticated, the Auth & Auth 352, will send a session and role message 528 to the enforcement component 354. The enforcement component 354 sends a get policy message 530 to the policy storage component 342 which retrieves the policy related to the identified user from the policy store 404. The request is evaluated 532 by the enforcement component 354 based on the retrieved access privileges for the role of the user. A response message 534 is provided by enforcement component 354 to the Auth & Auth 352. The Auth & Auth 352 issues 536 an access token 540. In this embodiment the access token 540 is a SAML token. The Auth & Auth 352 grants access 538 to the resource 114. The user 350 may then access 542 the resource 114.

Furthermore, the token 540 may be then sent to the user device 116 for re-use in tasks spanning multiple resources 114 for or for re-use of the same resource to undertake a later phase of the task.

The SAML token carries authentication and entitlement credentials, which allows authentication to occur in modem service based systems by, for example, an exchange of these credentials. For example, provisioning can only occur from a trusted source, that is, the identity management system or a resource which has the ability to provision a user with access privileges to enable use of a dependent resource in order for secondary phases of a task to be completed. That trust is carried in the form of credentials of the trusted source. SAML is used as a method of passing these credentials and session data when required to complete secondary phases of a task.

Furthermore, when a change to the user's role occurs such as, for example if a user changes positions or projects, the roles allocated to the user can be amended and the policies will cause the access privileges to change as necessary. These changes in access privileges may be provisioned to each resource by the distributor.

Further granularity can be provided for a session or other workflow basis for the purposes of task completion by-creating lower levels of group or task membership of a user in order to achieve a certain abnormal task related outcome above the substantive role based provisioning described above. Tasks outside of a given resource can be authorised using SAML to propagate a user's credentials between services or applications that need to be invoked for completion of a task. SAML is an XML-based standard for exchanging authentication and authorization data between a producer of identity assertions and a consumer of identity assertions. SAML is described in more detail in SAML standards published by OASIS. SAML is of assistance in providing a single sign-on solution because it can be used in an automatic forwarding of a user's (for example, a person or service) credentials via SAML exchange.

The identity management system and distributor may be separate systems although they can be integrated into one system. Each may be in the form of a hardware device or a combination of software and hardware, where the software is in the form of one or more computer programs which execute on so as to control one or more computers. The computer program may be recorded on a computer readable storage medium, such as for example memory or a non-volatile storage device, such as a disk, CD or DVD, flash memory etc. The identity management system and distributor made be connected to the resources by one or more computer networks, which may, for example, use wired Ethernet network connections, wireless network connections or other suitable forms of network component interconnections.

1. A system (100) for controlling access to distributed computing resources, the system comprising:
one or more computing resources (114);
an identity manager (102) arranged to register a plurality of users and create an access policy that comprises a set of rules that enable determination of access privileges of each registered user to access one or more of the computing resources;
a distributor (106) arranged to distribute the access policy to the one or more computing resources;
wherein each of the one or more computing resources have a policy applicator (110) for determining the access privileges for the respective computing resource from the distributed access policy, for determining whether the determined access privileges permit access to the respective computing resource when one of the registered users attempts to access the respective computing resource and for allowing access to the respective computing resource when the one of the registered users is permitted access thereto.

2. A system as claimed in claim 1, wherein the identity manager is configured to create the access policy by associating each user with one or more of a plurality of roles, where each role has a predetermined associated set of computing resource access privileges, and recording each association.

3. A system as claimed in claim 1, wherein the distributor is configured to distribute the access policy in the form of the recorded associations between each user and one or more roles and each role and the associated set of computing resource access privileges.

4. A system as claimed in claim 1, wherein the distributor is configured to distribute the access policy in the form of recorded associations between each user and access privileges for one or more of the computing resources.

5. A system as claimed in claim 1, wherein the distributor is arranged to only distribute one or more portions of the access policy to those computing resources for which the portions are relevant.

6. A system as claimed in claim 1, wherein each policy applicator comprises a storage device for storing the distributed access policy.

7. A method (200) of controlling access to one or more distributed computing resources, the method comprising:
distributing (208) an access policy that comprises a set of rules that enable determination of access privileges of a registered user to access one or more of the computing resources to the one or more computing resources;
determining (210) the access privileges for each respective computing resource from the distributed access policy;
determining (212) whether the access privileges permit access to one of the respective resources when the registered user attempts to access the respective resource; and
allowing (216) access to the respective computing resource when the registered user is permitted access thereto.

8. A method as claimed in claim 7, further comprising creating an access policy in the form of associations between each user and one or more roles, and associations between each role and one or more access privileges to one or more of the computing resources.

9. (canceled)

10. A method of controlling access to distributed computing resources, wherein the one or more resources each has a policy applicator for applying a distributed access policy so as to permit or deny access to the respective resource when a user attempts to access the computing resource, the method comprising:
creating (206) an access policy that comprises a set of rules that enable determination of access privileges of a registered user to access one or more of the computing resources;
distributing (208) the access policy to the one or more computing policy resources;
wherein the distributed access policy is suitable for the applicator of each resource to determine access privileges of the registered users to access the respective computing resource from the distributed access policy, to determined whether the access privileges permit access the respective resource, and to allow access to the respective computing resource when the user attempting access is permitted access thereto.

11. (canceled)

12. (canceled)

13. A computer program embodied in a computer readable medium, the program comprising instructions for controlling a computer to perform the method of claim 7.

14. A computer program embodied in a computer readable medium, the program comprises instructions for controlling one or more computers to operate as the system of claim 1.

15. A computer program embodied in a computer readable medium, the program comprising instructions for controlling a computer to perform the method of claim 10.
